(19) United States
(12) Patent Application Publication
(10) Pub. No.: US 2006/0120737 A1
(43) Pub. Date: Jun. 8, 2006

(54) Image forming device

(75) Inventor: Shigeyuki Takahashi, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/272,831

(22) Filed: Nov. 15, 2005

(30) Foreign Application Priority Data
Nov. 19, 2004 (JP) 2004-336315

(51) Int. Cl. G03G 15/08

(52) U.S. Cl. 399/27

(57) ABSTRACT

An image forming device in which printing can be conducted by mounting a plurality of toner cartridges of the same color, wherein a toner cartridge that caused degradation of image forming quality can be distinguished among the toner cartridges, is provided. The image forming device, in which a plurality of developing units accommodating toners of the same color are detachably mounted and image forming is conducted by using the toners accommodated, comprises an operation unit which receives a request to output a toner check sheet for inspecting the image forming quality of each of the developing units, a control unit which generates printing data for conducting image forming using respective developing units and instructs image forming based on the printing data, based on the request, and an image forming unit which executes image forming based on the printing data and outputs the toner check sheet, according to the instruction.

### CROSS-REFERENCE TO RELATED APPLICATIONS

This application is based upon and claims the benefit of priority from the prior Japanese Patent Application No. 2004-336315, filed on Nov. 19, 2004, the entire contents of which are incorporated herein by reference.

### BACKGROUND OF THE INVENTION

1. Field of the Invention

The present invention relates to an image forming device such as a printer, a facsimile, or a copier which forms images by using electrophotographic technology, and more particularly to an image forming device capable of distinguishing which toner cartridge causes quality degradation in forming images when printing is conducted by mounting a plurality of toner cartridges of the same color.

2. Description of the Related Art

In an image forming device such as a printer, a facsimile, or a copier which forms images by using electrophotographic technology, images are generally formed by forming an electrostatic latent image corresponding to image data, supplying a toner, which is a developing agent, to the electrostatic latent image to develop it into a toner image, and then transferring the toner image onto a medium that is a transfer object. Such devices detachably hold a toner cartridge accommodating the toner, and usually the devices for forming monochromatic images have one black toner cartridge mounted thereon and devices for forming color images have one toner cartridge of each color, for example, toner cartridges of four colors (yellow Y, magenta M, cyan C, and black K) mounted thereon. Those devices may be specifically designed for monochromatic printing or color printing, or they may be suitable for both the monochromatic and the color printing.

A method for outputting a toner check sheet is known as a method for inspecting the printing quality of mounted toner cartridges of each color during color printing. The toner check sheet has printed thereon a painted-out image obtained with a toner of each color, that is, each color cartridge, and the user determines the color for which quality degradation has occurred by visually inspecting the output toner check sheet. Thus, outputting a toner check sheet makes it possible to determine which color toner cartridge has caused printing quality degradation. The toner cartridge that caused quality image degradation is replaced.

In the case of monochromatic printing, as descried above, only one black toner cartridge is mounted. Therefore, if quality degradation is caused by a toner cartridge, it is clear that the mounted toner cartridge is degraded. Accordingly, the toner check sheet output during color printing is not used during monochromatic printing.

On the other hand, an image forming device having a plurality of toner cartridges of the same color mounted thereof has been suggested (Japanese Patent Application Laid-open No. 2002-351190) and this device was indicated to be useful for conducting large-volume monochromatic development.

As described hereinabove, the inspection of printing quality degradation of toner cartridges based on the output of a toner check sheet has not been conducted during monochromatic printing. Moreover, no method was suggested for inspecting printing quality degradation of toner cartridges in the case where a plurality of toner cartridges of the same color are mounted, as described in Japanese Patent Application Laid-open No. 2002-351190.

When a plurality of toner cartridges of the same color are mounted, for example, in a device for conducting monochromatic printing in which a plurality of black toner cartridges are mounted, the device automatically selects which toner cartridge is to be used during printing based on some indicator. For example, control is conducted to provide for a balanced use of each toner cartridge. Therefore, in such devices the user cannot easily determine which toner cartridge is used for printing and even if quality degradation is apparent in printing results, the toner cartridge that caused this quality degradation is difficult to be distinguished.

Furthermore, usually the user can determine the level of the remaining amount of toner in each cartridge, but because printing still can be conducted without any visible effects for a certain time after the level of the remaining amount has become close to the end level, the toner cartridge that caused quality degradation is likewise difficult to be distinguished when the level of the remaining amount of toner in a plurality of toner cartridges became close to the end level.

Thus, it is difficult to distinguish the toner cartridge that causes printing quality degradation when a plurality of toner cartridges of the same color are mounted.

### SUMMARY OF THE INVENTION

Accordingly, it is an object of the present invention to provide an image forming device in which printing can be conducted by mounting a plurality of toner cartridges of the same color, wherein the toner cartridge that caused degradation of image forming quality can be distinguished among the plurality of toner cartridges.

In order to attain the above-described object, the present invention in accordance with one aspect thereof provides an image forming device in which a plurality of developing units accommodating toners of the same color are detachably mounted and image forming is conducted by using the toners accommodated in the developing units, this image forming device comprising an operation unit which receives a request to output a toner check sheet for inspecting the image forming quality of each of the plurality of developing units, a control unit which generates printing data for conducting image forming using respective developing units and instructs image forming based on the printing data, based on the request received by the operation unit, and an image forming unit which executes image forming based on the printing data and outputs the toner check sheet, according to the instruction of the control unit. Therefore, in accordance with the present invention, in the device having a plurality of developing units of the same color mounted thereon, the developing unit that caused quality degradation can be easily distinguished.

Furthermore, in one implementation mode of the above-described present invention, the plurality of developing units accommodating the toners of the same color are a plurality of developing units accommodating black toners.

In the preferred implementation mode of the present invention, images formed in the toner check sheet to be output using the respective developing units are respectively provided with information for identifying the developing unit used for forming that image.

In order to attain the above-described object, the present invention in accordance with another aspect thereof provides an image forming device in which a plurality of developing units accommodating toners are detachably mounted and image forming is conducted by using the toners accommodated in the developing units, wherein the image can be formed at least in a first mode in which a prescribed number of the developing units accommodating toners of different colors are mounted and color printing is executed, and in a second mode in which the prescribed number of the developing units accommodating black toners are mounted and monochromatic printing is executed, the image forming device comprising an operation unit which receives a request to output a toner check sheet for inspecting the image forming quality of each the mounted developing unit in the first mode or the second mode, a control unit which, based on the request received by the operation unit, regardless of the type of the mode in which the request was made, generates printing data for conducting image forming using each of the prescribed number of developing units and instructs execution processing of the color printing based on the printing data, and an image forming unit which conducts execution processing of the color printing based on the printing data and outputs the toner check sheet, according to the instruction of the control unit.

In the preferred implementation mode of the present invention, images formed in the toner check sheet to be output using the respective developing units are respectively provided with information for identifying the developing unit used for forming that image.

Other objects and features of the present invention will become apparent from the embodiments of the present invention described hereinbelow.

### BRIEF DESCRIPTION OF THE DRAWINGS

FIG. 1 is a structural diagram of an embodiment of the image forming device employing the present invention;

FIG. 2 is a structural diagram illustrating mainly the mechanism of the engine 6 portion of the printer 2.

FIG. 3 is a flowchart illustrating the output processing of the check sheet in a BW 4 mode; and

FIG. 4 illustrates a toner check sheet output in a BW 4 mode.

### DESCRIPTION OF THE PREFERRED EMBODIMENTS

Embodiments of the present invention will be described hereinbelow with reference to the appended drawings. However, those embodiments place no limitation on the technological scope of the present invention. Identical or analogous elements in the figures are assigned with identical reference numerals or reference symbols.

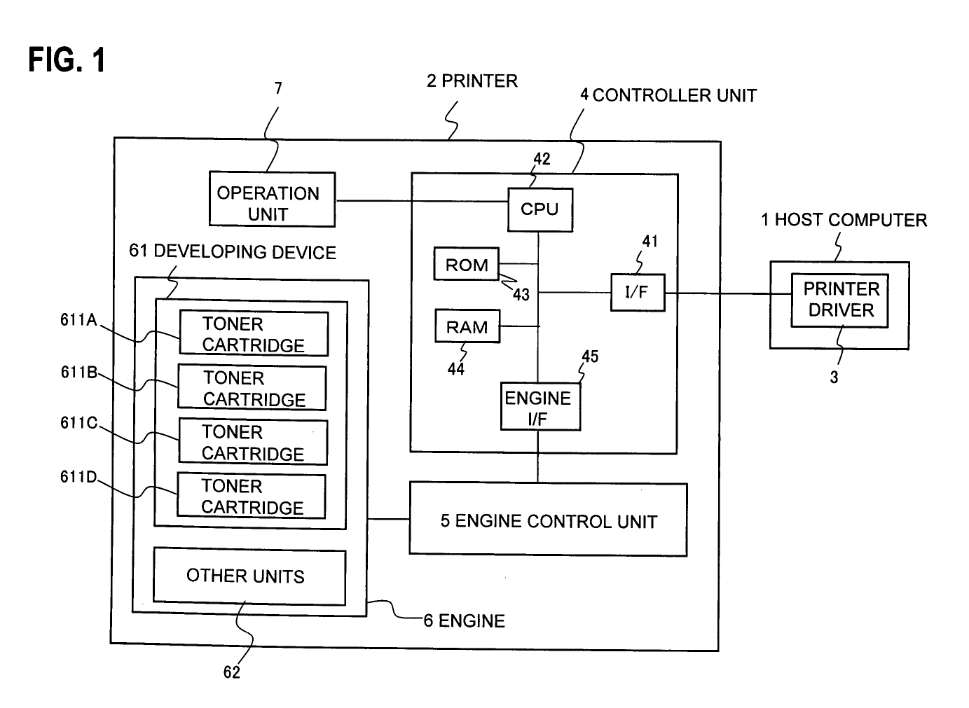

FIG. 1 is a structural diagram of an embodiment of a printer, which is an image forming device employing the present invention. A printer 2 shown in FIG. 1 is an image forming device employing the present invention and is a device which forms images of the prescribed printing medium (paper) based on a printing request from a host computer 1. This printer 2 is provided with a start mode allowing for monochromatic printing with a plurality of black toner cartridges 611 (developing units) when they are mounted thereon. During operation in this mode, a toner check sheet can be output and any of a plurality of black toner cartridges 611 in which printing quality degradation has occurred can be distinguished.

The host computer 1 shown in FIG. 1 is a host device which sends a printing request to the printer 2 and transmits, to the printer 2, printing data comprising image data and a control command following the operations by the user. The host computer 1 can be composed of a personal computer and so on. A printer driver 3 located inside the host computer 1 is a section for receiving data, e.g., from an application (not shown in the figure) located in the host computer 1 and generating the aforementioned printing data that will be transmitted to the printer 2.

Furthermore, the printer 2 is the so-called four-cycle laser printer comprising, as shown in FIG. 1, a controller unit 4, an engine control unit 5, an engine 6, and an operation unit 7. In addition to the Color mode this printer also has a BW4 mode as a start mode.

The Color mode is a mode for conducting color printing. In this mode, a toner cartridge 611 for each YMCK color is mounted in a respective specified location on the below-described developing device 61. Furthermore, the BW4 mode is a mode for conducting monochromatic printing. In this mode, K toner cartridges 611 are mounted in all (four) the mounting locations of the developing device 61.

The controller unit 4 receives printing data transmitted form the host computer 1, interprets the control command contained in the data, conducts the prescribed processing of image data contained in the printing data, and generates data to be supplied to the engine 6. The controller unit 4 comprises, as shown in FIG. 1, an I/F 41, a CPU 42 (a control unit), a ROM 43, a RAM 44, and an engine I/F 45.

The I/F 41 is a section for reserving the printing data transmitted from the host computer 1. The ROM 43 is a section for storing various programs for controlling the printer 2. The RAM 44 is a memory for storing the received printing data and the like. The image data of each page that are printing processes with the engine 6 are transferred therefrom to the engine I/F 45.

The CPU 42 controls processing of each type conducted in the printer 2, in particular, a processing of storing the image data contained in the received printing data in the RAM 44, a processing of interpreting the control command contained in the printing data and instructing the engine control unit 5 to conduct the adequate printing processing, and a processing of controlling the operation unit 7 which forms interface with the user. Furthermore, the output processing of a toner check sheet is a specific feature of the present printer 2, and this processing is also controlled by the CPU 42. Specific contents of the output processing of a toner check sheet will be described below. Furthermore, the processing executed by the CPU 42 is mainly conducted according to a program stored in the ROM 43.

The engine I/F 45 is an interface between the controller unit 4 and engine 6 and serves to read image data stored in the aforementioned RAM 44 at the prescribed timing when printing is executed with the engine 6 and to transfer them to the engine 6 after conducting the prescribed processing thereof. This engine I/F 45 comprises a memory for temporary storing data, a decompression unit, and a screen processing unit (not shown in the figure) for conducting decompression of compressed data and screen processing of converting to dot data with respect to the pixel data read out from the RAM 44. More specifically, the engine I/F 45 comprises an ASIC.

The engine control unit 5 comprises a CPU, a ROM, and a RAM (not shown in the figure) and controls the operation of each below-described unit of the engine 6. In the course of the output processing of the above-mentioned toner check sheet, the engine control unit receives the instructions of the CPU 42 and controls the engine 6 so as to print the toner check sheet.

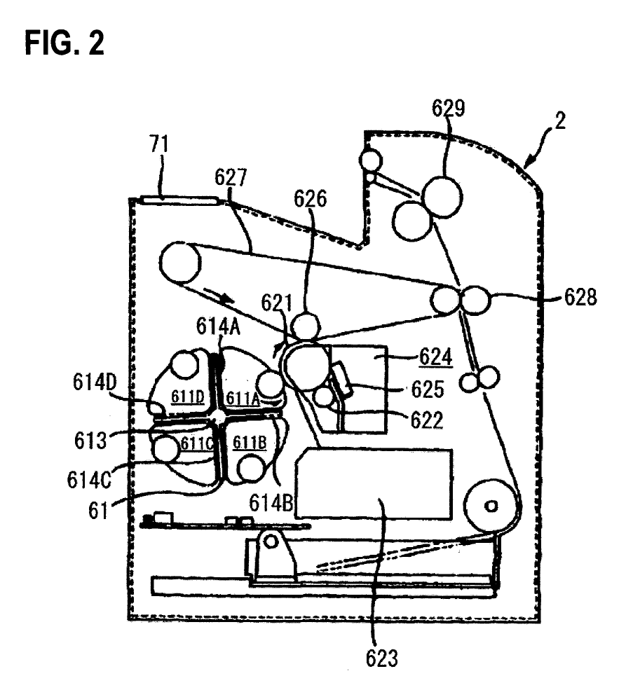

The engine 6 comprises a charging unit, an exposure unit, a developing device, and a transfer unit. In FIG. 1, the engine is represented by a block of the developing device 61 and a block of other units 62. FIG. 2 is a structural diagram illustrating mainly the mechanism of the engine 6 portion of the printer 2.

A photosensitive drum 621 has a cylindrical electrically conductive substrate and a photosensitive layer formed on the outer peripheral surface of the substrate and can rotate about the central axis thereof in the clockwise direction shown by an arrow. A charging unit 622 charges the photosensitive drum 621. An exposure unit 623 irradiates the charged photosensitive drum 621 with a beam from a light source such as a laser or a LED array contained therein and forms a latent image created by static electricity. Beam irradiation in the exposure unit 623 is controlled by drive signals modulated based on the image information input from the host computer 1.

The developing device 61 is a developing rotary unit having mounting units 614A-614D for detachably mounting toner cartridges 611A-611D accommodating toners, which are developing agents, and capable of rotating about a central axis 613. The latent image is developed into an image created by the developing agents by rotating the developing device 61, successively bringing the necessary toner cartridges 611A-611D close to the photosensitive drum 621 and supplying the developing agents to the photosensitive drum 621 where the latent image was formed.

Toner cartridges 611A-611D accommodating respective YMCK developing agents or toner cartridges 611A-611D all accommodating a K toner are mounted according to the above-mentioned start mode on the mounting portions 614A-614D of the developing device 61. Symbols A to D assigned to the toner cartridges 611A-611D serve to identify the mounting positions of toner cartridges 611 in the developing device 61.

A primary transfer unit 626 transfers the toner image formed on the photosensitive body 621 onto an intermediate transfer body 627. The intermediate transfer body 627 is an endless belt in which an aluminum vapor deposited layer is formed on the surface, for example, of a PET film and a semiconductor paint is formed on the surface of the aluminum layer. The endless belt is rotated with the same circumferential speed as the photosensitive drum 621. A secondary transfer body 628 serves to transfer the toner image formed on the intermediate transfer body 627 onto a printing medium such as paper, and a fixing unit 629 fixes the toner image transferred onto the printing medium to the medium to obtain a permanent image. The printed medium is then discharged out of the printer 2.

A cleaning unit 624 is provided between the primary transfer unit 626 and charging unit 622 and has a cleaning blade 625 that comes into contact with the surface of the photosensitive drum 621. The developing agent (toner) remaining on the photosensitive drum 621 after the primary transfer has been completed is removed with the cleaning blade 625.

The operation unit 7 shown in FIG. 1 is a section used by the user to operate the printer 2 and comprises a display panel 71 and an operation panel. Various operations such as setting of printing conditions in the printer 2 can be performed with the operation unit 7. The output operation of the above-described toner check sheet is also performed from the operation unit. More specifically, a menu of toner check sheet output that has been prepared for each above-described start mode is selected and printing of the toner check sheet is executed.

With the printer 2 of the embodiment having the above-described configuration, printing data described in the prescribed language are supplied from the host computer 1 at the time of printing, an electrostatic latent image is formed on the photosensitive drum 621, development is conducted with the corresponding toner cartridge 611, and the toner image is transferred to the intermediate transfer body 627 with the primary transfer unit 626. Then, the image is transferred to the printing medium such as paper with the secondary transfer unit 628, fixing is conducted with the fixing unit 629, and the printed medium is discharged from the printer 2.

During color printing in the Color mode, data of each color of YMCK are generated for each page in the controller unit 4 based on the printing data transmitted from the host computer 1, the printing data are sent successively to the engine 6 for each color, and the development is conducted for each color. Furthermore, in the BW4 mode, because monochromatic printing is conducted, the processing preceding the development is conducted based on the printing data for K only. Thus, during color printing, printing processing is conducted by successively using four mounted YMCK toner cartridges 611, whereas during monochromatic printing, printing processing is conducted by using one K toner cartridge 611.

The main operation contents of printer 2 is described above, but the output processing of the toner check sheet is a specific feature in the printer 2, and this issue will be explained below in greater detail.

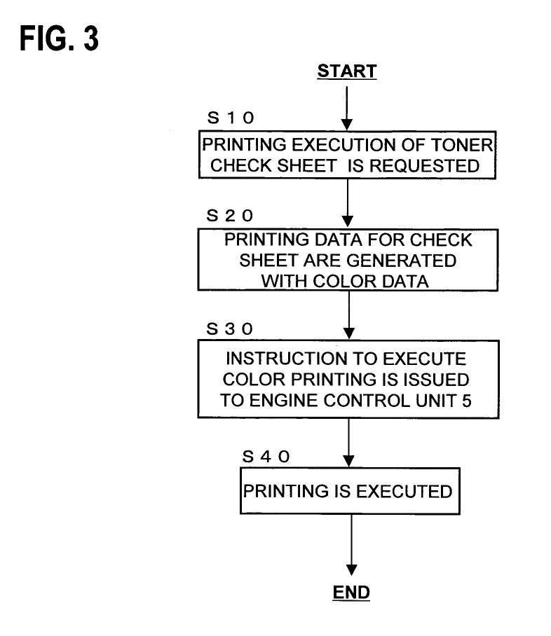

FIG. 3 is a flowchart illustrating an example of output processing of toner check sheet in the BW4 mode. The output of the toner check sheet in the BW4 mode, which is a specific feature of the printer 2, will be explained below with reference to FIG. 3.

First, in the case of abnormality, for example, when blurred images are obtained in monochromatic printing in the BW4 mode, the user issues a printing execution request for a toner check sheet in order to determine which K toner cartridge 611 caused quality degradation (step S10). More specifically, as described hereinabove, the user selects the menu of toner check sheet output from various menu displayed on the display panel 71 in the operation unit 7.

If the a printing execution request for a toner check sheet is issued, the request is received by the CPU 42 of the controller unit 4 and it generates printing data for toner check sheet with color data (step S20). Thus, printing data are generated that are identical to those relating to toner check sheet output in the Color mode. More specifically, printing data are generated such that painted-out images of each YMCK color are successively formed on paper in the Color mode. Thus, printing data are generated such that image formation is conducted by using each of the four mounted toner cartridges 611A-611D.

Then, the CPU 42 issues an instruction to the engine control unit 5 to execute color printing based on the generated data for the toner check sheet (step S30). More specifically, because the setting at this time is monochromatic printing in the BW4 mode, an instruction is issued to set color printing to the engine 6 and to execute printing based on the data for the toner check sheet.

The engine control unit 5 that received the instruction sets the engine 6 to color printing and controls the engine 6 to conduct printing processing based on the data for the toner check sheet fed from the controller unit 4. Following this control, the engine 6 executes printing and outputs a toner check sheet (step S40). Because the engine 6 has been set to color printing, a usual color printing operation is conducted with respect to the data that were fed and a toner check sheet is output.

More specifically, the development is successively conducted by using toner cartridges 611 corresponding to the data based on the data for toner check sheet that are fed for each color from the controller unit 4, after the development with the four toner cartridges 611 has been conducted, the above-described transfer processing is conducted and a toner check sheet is printed. Thus, for example, with respect to data for toner check sheet generated as Y data, the development processing is conducted by using the toner cartridge 611 mounted in the location where the Y toner cartridge 611 is mounted in the Color mode. Therefore, because the K toner cartridges 611 are actually mounted in all four mounting locations, four black painted-out images are formed.

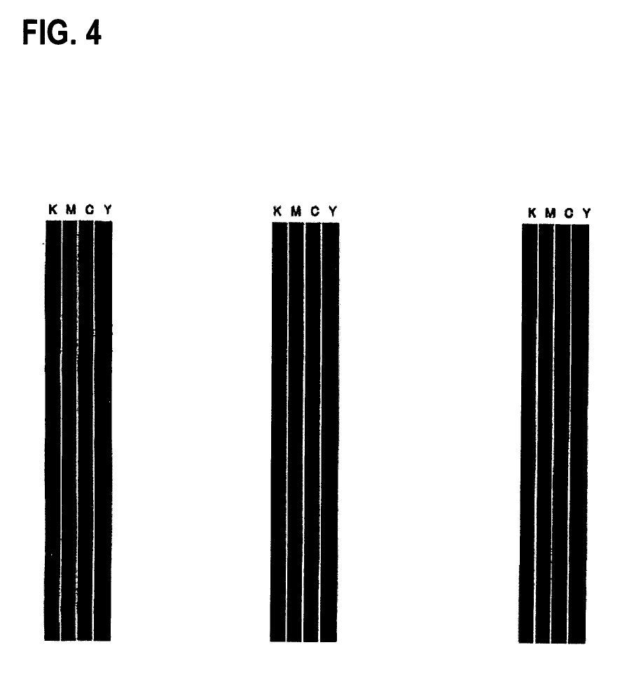

FIG. 4 illustrates an example of a toner check sheet output in the BW4 mode. The bar-like painted-out images shown in FIG. 4 are formed by using respective toner cartridges 611, and a symbol such as “K” assigned to each image serves to identify the toner cartridge 611 that related to the formation of the corresponding image. Thus, the image assigned with “K” is formed with the toner cartridge 611 mounted in the location where the K toner cartridge 611 is mounted in the Color mode. Information for identifying the toner cartridge 611 is identifiable by the user and other letters for symbols such as the above-described A-D letters can be also used. Furthermore, in the toner check sheet in FIG. 4, the formation of painted-out images with each toner cartridge 611 is conducted three times to inspect the degradation of printing quality with higher reliability.

If such a toner check sheet is output, the user can conduct visual inspection of the images formed on the toner check sheet and if an abnormality such as blurring is observed, the printing quality degradation is determined to be caused by the toner cartridge 611 corresponding to this image and the respective toner cartridge 611 is replaced.

The output processing of a toner check sheet in the BW4 mode is conduced in the above-described manner, but the output processing of the toner check sheet can be also similarly conducted in the Color mode. In the printer 2, a menu of toner check sheet output is also prepared in the Color mode and the user outputs the toner check sheet by selecting this menu from the operation unit 7. In the printer 2 that received the output request for a toner check sheet, processing is conducted similarly to the processing explained with reference to FIG. 3 and finally a toner check sheet corresponding to color printing is output, but because the engine 6 has already been set to color printing at the time of the output request for the toner check sheet, no modification of this setting is conducted. Furthermore, in the output toner check sheet, the painted-out images similar to the images shown as an example in FIG. 4, are formed correspondingly to the toner cartridges of each color. Thus, bar-like images of each YMCK color are formed.

As described hereinabove, the printer 2 of the present embodiment can operate in a mode for color printing and a mode for monochromatic printing in which four black toner cartridges 611 are mounted, and respective toner check sheets can be output in each mode. Furthermore, in the toner check sheet of the mode for monochromatic printing, painted-out images produced by four black toner cartridges 611 are formed, and the toner cartridge 611 that causes quality degradation can be determined by visual inspection. Therefore, even when a plurality of toner cartridges of the same color are mounted, it is possible to determine in which toner cartridge 611 quality degradation has occurred.

Furthermore, the output processing of the toner check sheet in the mode for monochromatic printing is conducted similarly to the output processing of the toner check sheet in the mode for color printing by changing settings to the color printing. Therefore, the output of the toner check sheet for the both modes can be realized comparatively easily.

Moreover, because the above-described identification information is attached to the painted-out image created by each toner cartridge 611 formed on the toner check sheet, the user can easily distinguish the toner cartridge 611 that causes quality degradation.

In the above-described embodiment, the printing execution request of the toner check sheet was issued by the user selecting of the printing execution request of the toner check sheet from the menu of the display panel 71 of the operation unit 7, but it can be also issued from the driver 3 installed in the host computer 1. In this case, for example, the driver 3 displays the menu on the display of the host computer 1 and the user selects the request.

Furthermore, in the above-described embodiment, the explanation was conducted with respect to an example of printing a toner check sheet in a printer with a BW4 mode where four developing units accommodating toners of the same color were mounted, but the present invention is also applicable to printing a toner check sheet in a printer in which two or more developing units accommodating toners of the same color are mounted and monochromatic printing operation is executed.

Furthermore, in the above-described embodiment, the explanation was conducted with respect to a painted-out image such as shown in FIG. 4 as an image formed on the toner check sheet, but, instead of a painted-out image, text or other figures, by which image formation quality can be verified, can be employed. In this case, a status sheet for printing the present state of the printer or settings may also serve as a toner check sheet. Furthermore, a sheet obtained by adding the painted-out image shown in FIG. 4 to the status sheet may be the toner check sheet.

Furthermore, in the above-described embodiment, the image forming device was a printer, but the present invention can be also employed in other image forming devices such as copiers of facsimile. Furthermore, it can be also employed in ink-jet printers where ink cartridges holding inks are used instead of the developing units in accordance with the present invention.

The protection scope of the present invention is not limited to the above-described embodiment and covers the inventions described in the claims and analogs thereof.

What is claimed is:

1. An image forming device in which a plurality of developing units accommodating toners of the same color are detachably mounted and image forming is conducted by using the toners accommodated in said developing units, said image forming device comprising:
an operation unit which receives a request to output a toner check sheet for inspecting the image forming quality of each of said plurality of developing units;
a control unit which generates printing data for conducting image forming using respective said developing units and instructs image forming based on said printing data, based on said request received by said operation unit; and
an image forming unit which executes image forming based on said printing data and outputs said toner check sheet, according to the instruction of said control unit.

2. The image forming device according to claim 1,
wherein the plurality of developing units accommodating said toners of the same color are a plurality of developing units accommodating black toners.

3. The image forming device according to claim 1 or claim 2, wherein
images formed in said toner check sheet to be output using said respective developing units are respectively provided with information for identifying said developing unit used for forming that image.

4. An image forming device in which a plurality of developing units accommodating toners are detachably mounted and image forming is conducted by using the toners accommodated in said developing units, wherein
said image can be formed at least in a first mode in which a prescribed number of said developing units accommodating toners of different colors are mounted and color printing is executed, and in a second mode in which said prescribed number of said developing units accommodating black toners are mounted and monochromatic printing is executed, said image forming device comprising:
an operation unit which receives a request to output a toner check sheet for inspecting the image forming quality of each said mounted developing unit in said first mode or said second mode;
a control unit which, based on said request received by said operation unit, regardless of the type of said mode in which said request was made, generates printing data for conducting image forming using each of said prescribed number of developing units and instructs execution processing of said color printing based on said printing data; and
an image forming unit which conducts execution processing of said color printing based on said printing data and outputs said toner check sheet, according to the instruction of said control unit.

5. The image forming device according to claim 4, wherein
images formed in said toner check sheet to be output using said respective developing units are respectively provided with information for identifying said developing unit used for forming that image.
